(19) United States
(12) Patent Application Publication
(10) Pub. No.: US 2017/0169040 A1
(43) Pub. Date: Jun. 15, 2017

(54) METHOD AND ELECTRONIC DEVICE FOR RECOMMENDING VIDEO

(71) Applicants: LE HOLDINGS (BEIJING) CO., LTD., Beijing (CN); LE SHI INTERNET INFORMATION TECHNOLOGY CORP. BEIJING, Beijing (CN)

(72) Inventor: Tao GUAN, Beijing (CN)

(73) Assignees: LE HOLDINGS (BEIJING) CO., LTD., Beijing (CN); LE SHI INTERNET INFORMATION TECHNOLOGY CORP. BEIJING, Beijing (CN)

(21) Appl. No.: 15/247,758

(22) Filed: Aug. 25, 2016

Related U.S. Application Data
(63) Continuation of application No. PCT/CN2016/088113, filed on Jul. 1, 2016.

(30) Foreign Application Priority Data
Dec. 15, 2015 (CN) 201510938060.2

(51) Int. Cl. G06F 17/30

(52) U.S. Cl. CPC G06F 17/3084; G06F 17/3053

(57) ABSTRACT

The disclosure discloses a method and an electronic device for recommending a video. The method includes: categorizing and ranking videos in each of categories according to a degree of popularity corresponding to each video, analyzing a preference value for each of the categories of each of user identities according to a browsing history, obtaining the preference values for each of the categories of a user identity logging in a terminal device according to the user identity logging in the terminal device and the preference value for each of the categories of each of user identities, and selecting and pushing one or more videos from each of the categories to the terminal device for displaying according to the preference value for each of the categories of the user logging in the terminal device and the ranking result. The popularity degree of the pushed videos rises and the user has no need to enter the keywords for searching manually and more convenient for user.

### CROSS REFERENCE TO RELATED APPLICATIONS

The present disclosure is a continuation of International Application No. PCT/CN2016/088113, filed on Jul. 1, 2016, which is based upon and claims priority to Chinese Patent Application No. 201510938060.2, titled “METHOD, DEVICE AND DEVICE FOR RECOMMENDING VIDEO”, filed on Dec. 15, 2015, the entire contents of all of which are incorporated herein by reference.

### TECHNICAL FIELD

The disclosure relates to the field of internet, and more particularly to a method and an electronic device for recommending a video.

### BACKGROUND

With the significant development of the smart phone and the tablet computer, the mobile video application develops and the mobile data stream increases tremendously. Nowadays, the mobile video is one of the main applications of the mobile networks and occupies 59% of the mobile data streams, so the mobile video becomes a driving force of the increase of the mobile data stream. Researches reveal that the amount of users watching television and time spent by users on television both decrease year by year while the amount of users watching video on demand and the amount of users watching videos via mobile terminal both increase explosively.

With the tremendous increasing of the amount of mobile video users, the competition in the market of mobile video application is getting more and more intense, the users have much higher requirement to mobile video applications. Researches reveal that the user opens a video application mainly for browsing videos, the content of the homepage is set by a server, and the homepage includes many categories such as television, movie, animation, originality, etc. When the user wants to watch certain video program, he or she often needs to take the name of the video or the name of the performer as the keyword to be inputted in the search bar and then to find out the video that he or she wants to watch in the search result.

Although the homepage of video application program has a block of “user preference” for recommending videos to the user, the contents in that block are not enough and may be the videos which the user has seen. A page displaying video in waterfall layout ways has no recommendation block; therefore it is not suitable for using the conventional recommendation ways.

### SUMMARY

One embodiment of the disclosure discloses a method for recommending a video, and the method includes: categorizing a video and ranking videos in each of categories according to a degree of popularity corresponding to each video; analyzing a preference value for each of the categories of each of user identities according to a browsing history; obtaining the preference values for each of the categories of a user identity logging in a terminal device according to the user identity logging in the terminal device and the preference value for each of the categories of each of user identities; and selecting and pushing one or more videos from each of the categories to the terminal device for displaying according to the preference value for each of the categories of the user logging in the terminal device and the ranking result.

One embodiment of the disclosure further discloses a non-volatile computer-readable storage medium storing computer executable instructions. The computer executable instructions are used for executing any of methods for recommending videos described above in the present disclosure.

One embodiment of the disclosure further discloses an electronic device including at least one processor; and a storage; wherein the storage stores instruction capable of being executed by the at least one processor: and the instructions are executed by the at least one processor to make the at least one processor able to execute any of the methods for recommending videos described above in the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for recommending a video in accordance with one embodiment of the present disclosure;

FIG. 2 is a block diagram of a device for recommending a video in accordance with one embodiment of the present disclosure; and

FIG. 3 is a block diagram of an electronic device in accordance with one embodiment of the present disclosure.

### DETAILED DESCRIPTION

In the embodiment of the present disclosure, the backend server classifies the videos and ranks the videos in each of the categories, and analyzes the preference value of each user to each of the categories. After the user logs in the server, the server determines the preference of the user to each of the categories and pushes corresponding amount of videos to the terminal device for displaying further according to a ranking result of the videos in each of the categories. With the video categorizing and the user analyzing in the backend, the effect of personalized recommending videos to users is improved and the recommended videos fits to the user preference more.

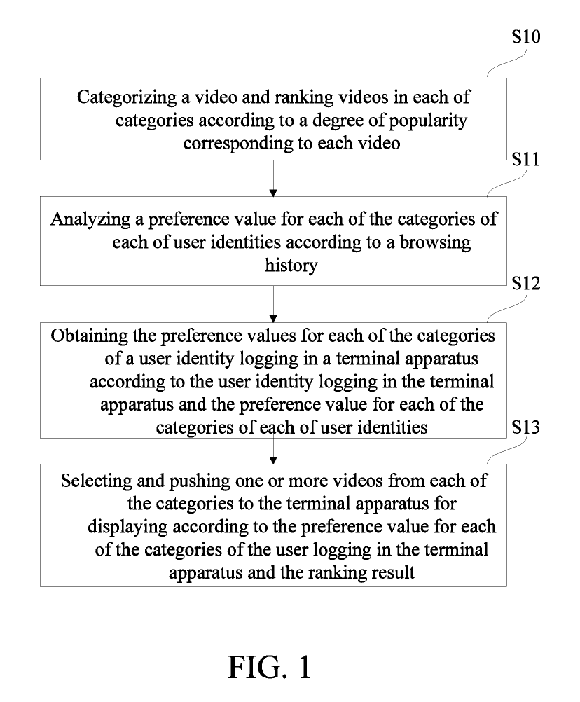

FIG. 1 is a method for recommending videos provided in one embodiment of the present disclosure. The method is applicable for a server, and the server may be a backend server corresponding to the video application program. As shown in FIG. 1, the method includes the steps S10 to S13.

In step S10, a video is categorized and videos are ranked in each of categories according to a degree of popularity corresponding to each video.

To categorize the videos may be according to the characteristic information of the video such as text characteristic name, performer, etc., or according to the image characteristic of the video. The same video may be classified into different categories. For example, a video of entertainment information may be classified into the entertainment category and the information category at the same time.

The degree of popularity of a video may be related to the factors such as the amount of clicking of the video, the score of the video, the comments to the video, etc. The degree of popularity is determined according the aforementioned factors, and the videos in each of the categories are ranked according to the degree of popularity so that a video with higher degree of popularity would be recommended to the user first.

In step S11, a preference value for each of the categories of each of user identities is analyzed according to a browsing history.

The browsing history is a history corresponding to each user identity (UserID) saved in the server, and the browsing history includes the videos shown in the page of the user and the videos clicked and viewed by the user. The videos in the browsing history are analyzed further according to the category classified in step S10 so as to obtain which category of videos is more interesting to the user.

Meanwhile, in the backend server, the saved videos are classified, and the preference value of each user identity to each category is obtained by analyzing the browsing history of the user. To one user identity, the preference values to all categories of the user identity may be combined to be a user profile of the user identity.

In step S12, the preference values for each of the categories of a user identity logging in a terminal device is obtained according to the user identity logging in the terminal device and the preference value for each of the categories of each of user identities.

After a user uses the terminal device to execute the video application program, and logs in the server by submitting the user identity, the password, and the verification code, the server obtains the preference value for each category of the user identity according to the user identity.

In step S13, one or more videos from each of the categories are selected and pushed to the terminal device for displaying according to the preference value for each of the categories of the user logging in the terminal device and the ranking result.

The probability of selecting a video from a category is determined by the preference value. With the ranking result in step S10, the video with higher rank is pushed to the video application program in the terminal device for displaying first.

For example, the homepage of the video application program is capable of displaying 20 videos. The user identity “Zhang San” has a preference value 0.4 to the videos in the entertainment category, and a preference value 0.5 to the videos in the sport category. Then, the videos displayed in the homepage include eight videos in the entertainment category and ten videos in the sport category. Further, they are the first eight videos in ranking in the entertainment category and the first ten videos in ranking in the sport category according to the ranking result in step S10.

The terminal device may be a mobile phone, a computer, a digital broadcasting terminal, an information transceiver, a controller platform on car, a gaming controller platform, a tablet device, a medical device, a fitting device, a personal digital assistant, etc. The videos pushed and displayed in the homepage of the video application program installed in the terminal device may be displayed with the waterfall layout. The waterfall layout shows multi-column layout in vision effect, and when the page is scrolled downwards, a preset amount of videos is loaded and appended to the tail of the current layout. When the data is loaded again, the server continues to select and push videos to the terminal device according to the aforementioned rule.

In the embodiment, the server classifies and ranks the videos and analyzes the preference of the user. The server selects the videos with high rank in the corresponding categories according to the preference of the user based on the logging in user identity, and pushes the videos to the homepage of the video application program for displaying. Hence, the user may directly watch the videos he or she prefers. Because the pushed videos are the videos with higher rank in each category, the degree of popularity of the pushed videos rises as well. Further, the user has no need to enter the keywords for searching manually so it's more convenient for the users.

In one embodiment, the degree of popularity of the video may be reflected by the total score, and the step S10 may further be implemented by the following steps S101-S103.

In step S101, characteristic information of the video is obtained.

The characteristic information may come from the text characteristic such as the title of the video, the source of the video, the introduction to the content of the video, etc. For example, the information in the title of the video such as the name of person, the name of a team, the name of a place, the name of a building, the name of a game, etc., the information in the source of the video such as the television station, the website, etc., and the information from the introduction to the content of the video such as the name of a person, the name of a team, the name of a place, the name of a building, the name of a game, etc. may be used as the text characteristic for categorizing the video.

The characteristic information may come from the image characteristic of the video images such as the image characteristic recognized by the image recognition technique including sport game, animation, news, movie, etc.; that may be the audio characteristic obtained by audio recognition technique such as the audio characteristic including jazz music, pop music, symphony, opera, comic dialog, etc.

In step S102, the video is categorized according to the characteristic information with a preset categorizing algorithm.

The preset categorizing algorithm may be a categorizing algorithm performing matching according to the characteristic information, or may be a categorizing machine trained by the training set specified for one among different categories such as support vector machine (SVM).

In step S103, the total score of each of the videos in each of the categories is calculated and sorted according the total score from high to low.

The total score may be calculated with the following formula:

Base Score (video)=Hotness (video)×Fresshness (video),

wherein BaseScore(video) represents the total score of the video, Hotness(video) represents a degree of popularity of the video, and Freshness(video) represents a freshness of the video.

The hotness, the number of times of the video being watched is more, and the hotness is getting higher; the freshness, the publishing time of the video is later, and the freshness is getting higher, and the possibility of which the user has not yet watched the video is getting higher.

The value of each of the hotness and the freshness may be from 1.0 to 10.0 with accuracy to the decimal place. For example, the “entertainment” category includes video A, video B, and video C. The hotness of the video A is Hotness(A)=6.0, and the freshness of the video A is Freshness(A)=4.0, so the total score of the video A is BaseScore(A)=24. The hotness of the video B is Hotness(B)=7.5, and the freshness of the video B is Freshness(B)=6.8, so the total score of the video B is BaseScore(B)=51. The hotness of the video C is Hotness(C)=8.8, and the freshness of the video C is Freshness(C)=7, so the total score of the video C is BaseScore(C)=61.6. Hence, the ranking results of the “entertainment” category are the video C, the video B, and the video A. The hotness and the freshness are considered in combination, and the video C is pushed to the user first.

In the embodiment, by calculating and ranking the total score of the video with hotness and freshness, the video which is the latest published and watched for the most times in each category is pushed to the user first. The possibility the user not yet watching these videos is very high, so it's more attractive to the users loving corresponding categories, and the fitness between the pushed video and the interest of the user is improved in advanced.

In one embodiment, the step S11 may further be implemented with the following steps S111-S113.

In step S111, an amount of exposure and an amount of clicking of videos in each of the categories corresponding to the user identity are obtained.

The amount of exposure indicates the number of the videos of certain category displayed in the page of the user. The amount of clicking indicates the number of times of the video of certain category clicked to be watched by the user. For example, the user identity “ABC123” has its page displaying 500 videos of the “entertainment” category, and the number of times the 500 videos watched by the user “ABC123” is 150, which includes the number of times one video being watched for several times, so the amount of exposure of videos in the “entertainment” category corresponding to the user “ABC123” is 500 and the amount of clicking is 150.

The amount of exposure and the amount of clicking of the user identity to each category is determined by the aforementioned method.

In step S112, the preference value for the category of the user identity is determined according to a ratio between the amount of exposure and the amount of clicking, and that is:

$$Favorite ( user , category ) = \frac{Click ( user , category )}{Exposure ( user , category )} \times 100 \%$$

Wherein category represents category, user represents the user identity, Click(user, category) represents the amount of clicking of the user identity for videos in the category, and Exposure(user, category) represents the amount of exposure of the video in the category when the user identity is logging in.

For example, in the aforementioned example, the amount of exposure of the videos of the “entertainment” category and the user “ABC123” is 500 and the amount of clicking is 150, so the preference value for the “entertainment” category of the user “ABC123” is 30% calculated by the aforementioned formula.

The preference value for each category of the user identity may be calculated by the aforementioned formula.

In step S113, a normalization process for the preference values of the category is performed, and that is:

$$NormaizeFavorite ( user , category ) = \frac{Favorite ( user , category )}{Max Favorite ( user , category )} ;$$

Wherein NormaizeFavorite(user, category) represents a normalized preference value, MaxFavorite(user, category) represents a max preference value for each of the categories of the user identity.

The purpose for performing the normalization process is to reflect the pushing probability of the new video in the corresponding category so as to ensure that the new video in the category which the user like the most is to be pushed.

For example, the user “ABC123” has the preference value of 30% to the “entertainment” category, the preference value of 60% to the “soccer” category, and the preference value of 45% to the “news” category, so the category with highest preference value is “soccer”. According to the aforementioned formula, a normalized preference value of the user “ABC123” to the “entertainment” category is 30%/60%=0.5, and a normalized preference value to the “soccer” category is 60%/60%=1, and a normalized preference value to the “news” category is 45%/60%=0.75. Hence, if a new video in the “soccer” category is published, it is definitely pushed to the user. If a new video in the “entertainment” category is published, it is pushed to the user with the probability of 0.5. If a new video in the “news” category is published, it is pushed to the user with the probability of 0.75.

In the embodiment, by calculating the preference value according to the amount of exposure and the amount of clicking of the user to the videos in each category and by the normalization process, the category which the user is the most interested in is obtained and the probability of pushing the video in this category is set to be 1, so the new published video in that category is definitely pushed to the user. The pushing efficiency for the videos in the category the user the most interested in is improved. Surely, with the variation of the browsing activity of the user, the pushing probability of each category is adjusted accordingly. The pushing probability of the videos in the category with the highest preference value is the highest.

In one embodiment, the step S13 may be further implemented with the following steps S131-133.

In step S131, one or more videos from each of the categories are selected according to the preference value for each of the categories of the user logging in the terminal device and the ranking result.

First, the category selected first is determined according to the preference value for each of the categories of the user identity logging in. The videos of the category having larger preference value or larger normalized preference value have higher probability to be selected. Then, the corresponding videos are selected according to the ranking result of the videos of each of the categories till the amount of the selected videos reaches the preset amount, e.g. 30.

In step S132, one or more videos which have been exposed to the user identity logging in the terminal device are filtered out from the selected videos.

It is determined whether the selected video has been exposed in the page of the user within a preset period of time such as one week or watched by the user within that preset period of time according to the browsing history corresponding to the user identity. If the selected video has been exposed or watched, it means that the video has been pushed to the user and the user has seen the video. Then, the corresponding video is filtered out from the selected videos, and another video among the videos in the corresponding category is selected for replacement according to the ranking result till the aforementioned requirement is satisfied. Hence, the videos which have not been pushed are pushed to the user and the event decreasing the watching desire of the user because the pushed videos include the video seen by the user is prevented.

In step S133, the filtered videos are pushed to the terminal device for displaying.

In the embodiment, the selected videos are filtered so that the video which has been pushed during a preset time period is filtered out, so the pushed videos are videos not yet being watched by the user and the watching rate of the pushed videos is improved.

In one embodiment, the step S13 may further implemented by the following steps S134-S136.

In step S134, one or more videos are selected from each of the categories according to the preference value for each of the categories of the user logging in the terminal device and the ranking result.

In step S135, the selected videos are scored and ranked, wherein an amount of the videos belonging to the same category in a ranking result is less than or equal to a preset amount.

When scoring the selected videos, there are many factors to be considered including the positive factors for increasing the score and the negative factor for degrading the score. As to the positive factors, the values thereof may be between 1.0 and 10.0. As to the negative factors, the values thereof may be between 0.01 and 0.99.

The positive factors may include hotness, timeliness, amount of viewing, etc., and the negative factors may include the garbage index, the porn index, the amount of being reported, etc. The garbage index indicates that the content of the video is disliked by the users in network or the view effect is not good because there is defect in audio or image of the video. The porn index indicates the degree of which the video should not be viewed by teenagers. The amount of being reported indicates the number of times the video being reported by the users in the network for defect or illegal information.

For example, the formula below may be used for scoring the selected videos:

Score (user, video)=BaseScore (video)×UserFavorite(category, video)×Freshness(video)× . . .

Wherein, BaseScore(video) is the total score of the video, UserFavorite(category, video) is the preference value for the category which the video belongs to of the user, Freshness(video) is the novelty of the video in time, the ellipsis in last indicates other positive factors and negative factors which can be considered in combination so as to score the selected video. For example, the total score of the video A is 24, and the preference value for the corresponding category of the user is 50%, and the novelty of the video in time is 4.0, and the hotness is 6.0, and the garbage index and the porn index are both 0.95, so the result of scoring the video is: Score=24×50%×4.0×6.0×0.95×0.95=259.92.

By scoring the selected videos with the aforementioned method, and ranking the selected videos from high score to low score according to the scoring result, the selected videos are pushed to the terminal device in sequence according to the ranking result. In the ranking result, there might be videos in the same category appearing successively, so a threshold value may be set for the amount of the videos in the same category appearing successively such as four. When the amount of the videos in the same category appearing successively is larger than four, one or more other videos with highest rank in the ranking result are inserted before the fifth video in the same category. Hence, the diversity is achieved, and the unitary of the categories of the pushed videos is prevented.

For example, the first five videos, including videos 1 to 5, in the ranking result all belong to the sport category, and the sixth is the video 6 of the entertainment category, and the seventh is the video 7 of the news category, and the eighth is the video 8 of the sport category. Meanwhile, the amount of the videos of the sport category appearing successively is more than four, so the video 6 with higher ranking result is adjusted to be between the video 4 and the video 5. The adjusted ranking result is shown below:

video 1, video 2, video 3, video 4, video 6, video 5, video 7, video 8.

In step S136, the ranked videos are pushed to the terminal device for displaying.

In the embodiment, the selected videos are scored and ranked according to the scoring result. The video having higher score is recommended to the user first, so the video program with better quality is pushed first. In the process of ranking, the diversity may be adjusted. The diversity of the pushed videos is kept by inserting videos of other categories when the number of times of the appearance of the videos of the same category is too many.

In addition, the aforementioned method for filtering the exposed videos and the method for scoring, ranking and adjusting the diversity for videos may be combined so as to filter out the videos watched by the user recently from the selected videos and to keep the diversity of the pushed videos.

The embodiment of the present disclosure further provides a non-volatile computer storage medium. The computer storage medium stores the computer executable instructions and the computer executable instructions may execute the method for recommending videos in any of the aforementioned embodiment of the present disclosure.

The embodiment of the present disclosure further provides a device for recommending videos, and the following is the embodiment of the device in the disclosure capable of executing the method in the embodiment of the disclosure.

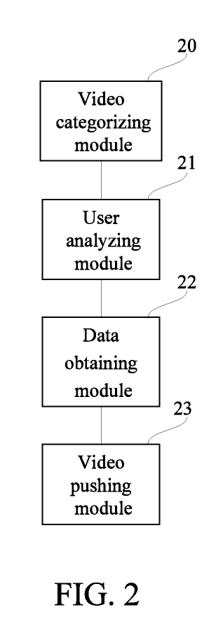

FIG. 2 is a block diagram of a device for recommending a video in accordance with one embodiment of the present disclosure. The device is in the server side. The device includes a video categorizing module 20, a user analyzing module 21, a data obtaining module 22, and a video pushing module 23.

The video categorizing module 20 is electrically connected to the user analyzing module 21 and used for categorizing a video and ranking videos in each of categories according to a degree of popularity corresponding to each video.

The user analyzing module 21 is electrically connected to the data obtaining module 22 and used for analyzing a preference value for each of the categories of each of user identities according to a browsing history.

The data obtaining module 22 is electrically connected to the video pushing module 23 and used for obtaining the preference values for the categories of a user identity logging in a terminal device according to the user identity logging in the terminal device and the preference value for each of the categories of each of user identities.

The video pushing module 23 is used for selecting and pushing one or more videos from each of the categories to the terminal device for displaying according to the preference value for each of the categories of the user logging in the terminal device and the ranking result.

In one embodiment, the degree of popularity corresponding to each video is a total score of the video, and the video categorizing module 20 further includes a first obtaining sub-module, a categorizing sub-module and a first ranking sub-module.

The first obtaining sub-module is electrically connected to the categorizing sub-module and used for obtaining characteristic information of the video;

The categorizing sub-module is electrically connected to the first ranking sub-module and used for categorizing the video according to the characteristic information with a preset categorizing algorithm;

The first ranking sub-module is used for calculating the total score of each of the videos in each of the categories, and ranking according the total score from high to low.

The first ranking sub-module includes:

Base Score (video)=Hotness (video)×Freshness (video);

wherein BaseScore(video) represents the total score of the video, Hotness(video) represents a hotness of the video, and Freshness(video) represents a freshness of the video.

In one embodiment, the user analyzing module 21 further includes a second obtaining sub-module, a determining sub-module and a normalizing sub-module.

The second obtaining sub-module is electrically connected to the determining sub-module and used for obtaining an amount of exposure and an amount of clicking of videos in each of the categories corresponding to the user identity;

The determining sub-module is electrically connected to the normalizing sub-module and used for determining the preference value for the category of the user identity according to a ratio between the amount of exposure and the amount of clicking, and that is:

$$Favorite ( user , category ) = \frac{Click ( user , category )}{Exposure ( user , category )} \times 100 \% ;$$

Wherein category represents category, user represents the user identity, Click(user, category) represents the amount of clicking of the user identity for videos in the category, and Exposure(user, category) represents the amount of exposure of the video in the category when the user identity is logging in;

The normalizing sub-module is used for performing an normalization process for the preference values of the category, and that is:

$$NormaizeFavorite ( user , category ) = \frac{Favorite ( user , category )}{Max Favorite ( user , category )} ;$$

Wherein NormaizeFavorite(user, category) represents a normalized preference value, MaxFavorite(user, category) represents a max preference value for each of the categories of the user identity.

In one embodiment, the video pushing module 23 further includes a first selecting sub-module, a filtering sub-module and a first pushing sub-module.

The first selecting sub-module is electrically connected to the filter sub-module and used for selecting one or more videos from each of the categories according to the preference value for each of the categories of the user logging in the terminal device and the ranking result;

The filtering sub-module is electrically connected to the first pushing sub-module and used for filtering out one or more videos which have been exposed to the user identity logging in the terminal device from the selected videos;

The pushing sub-module is used for pushing the filtered videos to the terminal device for displaying.

In one embodiment, the video pushing module 23 further includes a second selecting sub-module, a second ranking sub-module and a second pushing sub-module.

The second selecting sub-module is electrically connected to the second ranking sub-module and used for selecting one or more videos from each of the categories according to the preference value for each of the categories of the user logging in the terminal device and the ranking result;

The second ranking sub-module is electrically connected to the second pushing sub-module and used for scoring and ranking the selected videos, wherein an amount of the videos belonging to the same category in the ranking result is less than or equal to a preset amount;

The second pushing sub-module is used for pushing the ranked videos to the terminal device for displaying.

In addition, the embodiment of the present disclosure may implement the aforementioned functional modules by a hardware processor.

The embodiments of the present disclosure further provide a non-volatile computer-readable storage medium, the non-volatile computer-readable storage medium is stored with computer executable instructions, the computer executable instructions perform the method for recommending a video in any embodiment described above.

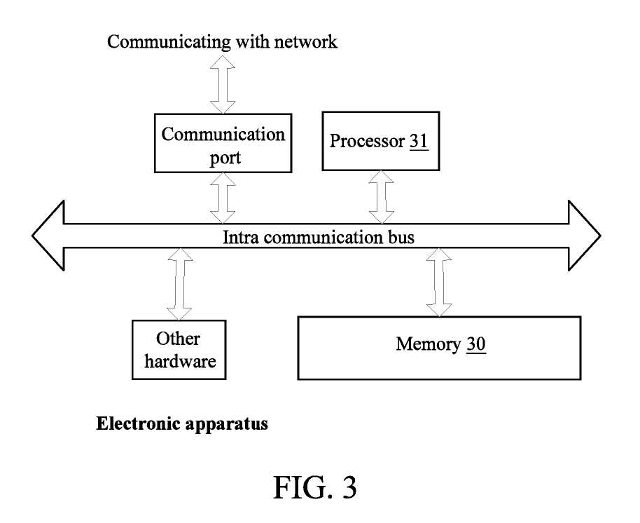

FIG. 3 is a block diagram of an electronic devicedevice performing the method for recommending videos provided in one embodiment of the present disclosure. As shown in FIG. 3, the devicedevice includes:

One or more processors 31 and a memory 30. One processor 31 is for example in FIG. 3.

The processor 31 and the memory 30 may be in connection via bus or other means. Connection via bus is for example in FIG. 3.

The memory 30 is a non-volatile computer readable storage medium and used for storing the non-volatile software process, non-volatile computer executable process and modules such as the process instructions/modules corresponding to the method for recommending videos in the embodiment of the present disclosure. The processor 31 executes the functional applications and data processing of the server by executing the non-volatile software process, instructions and modules stored in the memory 30 so as to implement the method for recommending videos in aforementioned embodiment of the present disclosure.

The memory 30 may include process storage sections and data storage sections, wherein the process storage sections may store the operating system, at least one application process needed by the functionality; and the data storage sections may store the data created by using the processing device for recommending videos. In addition, the memory 30 may include high-speed random access memory and non-volatile memory such as at least disk storage, a flash memory, or other non-volatile solid state storage. In some embodiments, the memory 30 selectively includes storages remotely set compared with the processor 31, and these remote storages may be connected to the processing device for recommending videos via network. The embodiment of the aforementioned network includes but not limits to internet, enterprise intranet, local area network, mobile communication network and combination thereof.

The one or more modules are stored in the memory 30, and execute the method for recommending videos in any of the aforementioned embodiments when executed by the one or more processors 31.

The aforementioned product may execute the method provided by the embodiment of the present disclosure and have corresponding functional blocks and the benefit effect of executing the method. The technique detail not detailed described in the embodiment may refer to the method provided in the embodiment of the present disclosure.

The device includes a processor 31 and a memory 30 used for storing instructions executable by the processor;

wherein the processor 31 is configured to categorize a video and ranking videos in each of categories according to a degree of popularity corresponding to each video, to analyze a preference value for each of the categories of each of user identities according to a browsing history, to obtain the preference values for the categories of a user identity logging in a terminal device according to the user identity logging in the terminal device and the preference value for each of the categories of each of user identities, and to select and push one or more videos from each of the categories to the terminal device for displaying according to the preference value for each of the categories of the user logging in the terminal device and the ranking result.

The degree of popularity of the video is the total score of the video, and the step of categorizing the video and ranking the videos in each of the categories according to the degree of popularity corresponding to each video includes: obtaining characteristic information of the video; categorizing the video according to the characteristic information with a preset categorizing algorithm; and calculating the total score of each of the videos in each of the categories, and ranking according the total score from high to low.

The calculation of the total score of each video among the category includes:

Base Score (video)=Hotness (video)×Freshness (video);

wherein BaseScore(video) represents the total score of the video, Hotness(video) represents a hotness of the video, and Freshness(video) represents a freshness of the video.

The step of analyzing the preference value for each of the categories of each of user identities according to the browsing history comprises: obtaining an amount of exposure and an amount of clicking of videos in each of the categories corresponding to the user identity; determining the preference value for the category of the user identity according to a ratio between the amount of exposure and the amount of clicking, and that is:

$$Favorite ( user , category ) = \frac{Click ( user , category )}{Exposure ( user , category )} \times 100 \% ;$$

Wherein category represents category, user represents the user identity, Click(user, category) represents the amount of clicking of the user identity for videos in the category, and Exposure(user, category) represents the amount of exposure of the video in the category when the user identity is logging in;

Performing a normalization process for the preference values of the category, and that is:

$$NormaizeFavorite ( user , category ) = \frac{Favorite ( user , category )}{Max Favorite ( user , category )} ;$$

Wherein NormaizeFavorite(user, category) represents a normalized preference value, MaxFavorite(user, category) represents a max preference value for each of the categories of the user identity.

The step of selecting and pushing one or more videos from each of the categories to the terminal device for displaying according to the preference value for each of the categories of the user logging in the terminal device and the ranking result comprises: selecting one or more videos from each of the categories according to the preference value for each of the categories of the user logging in the terminal device and the ranking result; filtering out one or more videos which have been exposed to the user identity logging in the terminal device from the selected videos; and pushing the videos after filtering to the terminal device for displaying.

The step of selecting and pushing one or more videos from each of the categories to the terminal device for displaying according to the preference value for each of the categories of the user logging in the terminal device and the ranking result comprises: selecting one or more videos from each of the categories according to the preference value for each of the categories of the user logging in the terminal device and the ranking result; scoring and ranking the selected videos, wherein an amount of the videos belonging to the same category in the ranking result is less than or equal to a preset amount; and pushing the ranked videos to the terminal device for displaying.

The electronic device in the embodiments of the present application is presence in many forms, and the electronic device includes, but not limited to:

(1) Mobile communication device: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer device: this type of device belongs to the category of personal computers, there are computing and processing capabilities, generally includes mobile Internet characteristic. This type of terminals include: PDA, MID and UMPC equipment, etc., such as iPad.

(3) Portable entertainment device: this type of device can display and play multimedia contents. This type of device includes: audio, video player (e.g. iPod), handheld game console, e-books, as well as smart toys and portable vehicle-mounted navigation device.

(4) Server: an device provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic device having a data exchange function.

The aforementioned embodiment of device is only exemplary, and the unit illustrated as separated member may be or may be not separated physically, and member shown in unit may be or may be not a physical unit, which means the unit may be located in one place or distributed on many network units. Part or all modules may be selected according to real need to implement the purpose of the solution of the present embodiment.

With the description of the aforementioned embodiments, one having ordinary skill in the art may clearly understand that each embodiment may be implemented by software in combination of the general purpose hardware platform or by hardware. Based on such understanding, the aforementioned solution itself or the contribution to the related art, including some instructions for making a computing device such as a personal computer, a server, or network device to execute the method of each embodiment or part of embodiments, may be implemented by software product. The computer software product may be stored in the computer readable storage medium such as ROM/RAM, disk, compact disc, etc.

Last but not least, the aforementioned embodiments are not to limit the present disclosure but used for illustrating the technique solution of the present disclosure. Although the aforementioned embodiments illustrate the present disclosure in detail, one having ordinary in the art should understand that he or she may still modify the technique solution described in each of the aforementioned embodiment or equivalently replace part of the technique feature therein; and these modifications or replacements wouldn't make the core of corresponding technique solution beyond the spirit or scope of the technique solutions of each embodiment of the present disclosure.

What is claimed is:

1. A method for recommending a video, applied in an electronic device, comprising:
categorizing a video and ranking videos in each of categories according to a degree of popularity corresponding to each video;
analyzing a preference value for each of the categories of each of user identities according to a browsing history;
obtaining the preference values for each of the categories of a user identity logging in a terminal device according to the user identity logging in the terminal device and the preference value for each of the categories of each of user identities; and
selecting and pushing one or more videos from each of the categories to the terminal device for displaying according to the preference value for each of the categories of the user logging in the terminal device and the ranking result.

2. The method according to claim 1, wherein the degree of popularity corresponding to each video is a total score of the video;
the step of categorizing the video and ranking the videos in each of the categories according to the degree of popularity corresponding to each video comprises:
obtaining characteristic information of the video;
categorizing the video according to the characteristic information with a preset categorizing algorithm; and
calculating the total score of each of the videos in each of the categories, and ranking according the total score from high to low.

3. The method according to claim 2, wherein the step of calculating the total score of each of the videos in each of the categories comprises:
Base Score (video)=Hotness (video)×Freshness (video);
wherein BaseScore(video) represents the total score of the video, Hotness(video) represents a hotness of the video, and Freshness(video) represents a freshness of the video.

4. The method according to claim 1, wherein the step of analyzing the preference value for each of the categories of each of user identities according to the browsing history comprises:
obtaining an amount of exposure and an amount of clicking of videos in each of the categories corresponding to the user identity;
determining the preference value for the category of the user identity according to a ratio between the amount of exposure and the amount of clicking, and
$$Favorite ( user , category ) = \frac{Click ( user , category )}{Exposure ( user , category )} \times 100 \% ;$$
wherein category represents category, user represents the user identity, Click(user, category) represents the amount of clicking of the user identity for videos in the category, and Exposure(user, category) represents the amount of exposure of the video in the category when the user identity is logging in;
performing a normalization process for the preference values of the category, which comprises:
$$NormaizeFavorite ( user , category ) = \frac{Favorite ( user , category )}{Max Favorite ( user , category )} ;$$
Wherein NormaizeFavorite(user, category) represents a normalized preference value, MaxFavorite(user, category) represents a max preference value for each of the categories of the user identity.

5. The method according to claim 1, wherein the step of selecting and pushing one or more videos from each of the categories to the terminal device for displaying according to the preference value for each of the categories of the user logging in the terminal device and the ranking result comprises:
selecting one or more videos from each of the categories according to the preference value for each of the categories of the user logging in the terminal device and the ranking result;
filtering one or more videos which have been exposed to the user identity logging in the terminal device from the selected videos; and
pushing the videos after filtering to the terminal device for displaying.

6. The method according to claim 1, wherein the step of selecting and pushing one or more videos from each of the categories to the terminal device for displaying according to the preference value for each of the categories of the user logging in the terminal device and the ranking result comprises:
selecting one or more videos from each of the categories according to the preference value for each of the categories of the user logging in the terminal device and the ranking result;
scoring and ranking the selected videos, wherein an amount of the videos belonging to the same category in the ranking result is less than or equal to a preset amount; and
pushing the ranked videos to the terminal device for displaying.

7. A non-volatile computer-readable storage medium storing computer executable instructions that, when executed by an electronic device, cause the electronic device to:
categorize a video and rank videos in each of categories according to a degree of popularity corresponding to each video;
analyze a preference value for each of the categories of each of user identities according to a browsing history;
obtain the preference values for each of the categories of a user identity logging in a terminal device according to the user identity logging in the terminal device and the preference value for each of the categories of each of user identities; and
select and push one or more videos from each of the categories to the terminal device for displaying according to the preference value for each of the categories of the user logging in the terminal device and a ranking result.

8. The non-volatile computer-readable storage medium according to claim 7, wherein the degree of popularity corresponding to each video is a total score of the video, and the instructions to categorize the video and ranking the videos in each of the categories according to the degree of popularity corresponding to each video cause the electronic device to:
obtain characteristic information of the video;
categorize the video according to the characteristic information with a preset categorizing algorithm; and
calculate the total score of each of the videos in each of the categories, and ranking according the total score from high to low.

9. The non-volatile computer-readable storage medium according to claim 8, wherein the instructions to calculate the total score of each of the videos in each of the categories cause the electronic device to:
Base Score (video)=Hotness (video)×Freshness (video);
wherein BaseScore(video) represents the total score of the video, Hotness(video) represents a degree of popularity of the video, and Freshness(video) represents a freshness of the video.

10. The non-volatile computer-readable storage medium according to claim 7, wherein the instructions to analyze the preference value for each of the categories of each of user identities according to the browsing history cause the electronic device to:
obtain an amount of exposure and an amount of clicking of videos in each of the categories corresponding to the user identity;
determine the preference value for the category of the user identity according to a ratio between the amount of exposure and the amount of clicking, and
$$Favorite ( user , category ) = \frac{Click ( user , category )}{Exposure ( user , category )} \times 100 \% ;$$
wherein category represents category, user represents the user identity, Click(user, category) represents the amount of clicking of the user identity for videos in the category, and Exposure(user, category) represents the amount of exposure of the video in the category when the user identity is logging in;
perform a normalization process for the preference values of the category, which comprises:
$$NormaizeFavorite ( user , category ) = \frac{Favorite ( user , category )}{Max Favorite ( user , category )} ;$$
wherein NormaizeFavorite(user, category) represents a normalized preference value, MaxFavorite(user, category) represents a max preference value for each of the categories for the user identity.

11. The non-volatile computer-readable storage medium according to claim 7, wherein the instructions to select and push one or more videos from each of the categories to the terminal device for displaying according to the preference value for each of the categories of the user logging in the terminal device and the ranking result cause the electronic device to:
select one or more videos from each of the categories according to the preference value for each of the categories of the user logging in the terminal device and the ranking result;
filter one or more videos which have been exposed to the user identity logging in the terminal device from the selected videos; and
push the videos after filtering to the terminal device for displaying.

12. The non-volatile computer-readable storage medium according to claim 7, wherein the instructions to select and push one or more videos from each of the categories to the terminal device for displaying according to the preference value for each of the categories of the user logging in the terminal device and the ranking result cause the electronic device to:
select one or more videos from each of the categories according to the preference value for each of the categories of the user logging in the terminal device and the ranking result;
score and ranking the selected videos, wherein an amount of the videos belonging to the same category in the ranking result is less than or equal to a preset amount; and
push the ranked videos to the terminal device for displaying.

13. An electronic device, comprising:
at least one processor; and
a memory communicably connected with the at least one processor for storing instructions executable by the at least one processor, wherein execution of the instructions by the at least one processor causes the at least one processor to:
categorize a video and rank videos in each of categories according to a degree of popularity corresponding to each video;
analyze a preference value for each of the categories of each of user identities according to a browsing history;
obtain the preference values for each of the categories of a user identity logging in a terminal device according to the user identity logging in the terminal device and the preference value for each of the categories of each of user identities; and
select and push one or more videos from each of the categories to the terminal device for displaying according to the preference value for each of the categories of the user logging in the terminal device and the ranking result.

14. The electronic device according to claim 13, wherein the degree of popularity corresponding to each video is a total score of the video, and the execution of the instructions to categorize the video and rank the videos in each of the categories according to the degree of popularity corresponding to each video cause the at least one processor to:
obtain characteristic information of the video;
categorize the video according to the characteristic information with a preset categorizing algorithm; and
calculate the total score of each of the videos in each of the categories, and ranking according the total score from high to low.

15. The electronic device according to claim 14, wherein the execution of the instructions to calculate the total score of each of the videos in each of the categories cause the at least one processor to:
Base Score (video)=Hotness (video)×Freshness (video);
wherein BaseScore(video) represents the total score of the video, Hotness(video) represents a hotness of the video, and Freshness(video) represents a freshness of the video.

16. The electronic device according to claim 13, wherein the execution of the instructions to analyze the preference value for each of the categories of each of user identities according to the browsing history cause the at least one processor to:
obtain an amount of exposure and an amount of clicking of videos in each of the categories corresponding to the user identity;
determine the preference value for the category of the user identity according to a ratio between the amount of exposure and the amount of clicking, and
$$Favorite ( user , category ) = \frac{Click ( user , category )}{Exposure ( user , category )} \times 100 \% ;$$
wherein category represents category, user represents the user identity, Click(user, category) represents the amount of clicking of the user identity for videos in the category, and Exposure(user, category) represents the amount of exposure of the video in the category when the user identity is logging in;
perform a normalization process for the preference values of the category, which comprises:
$$NormaizeFavorite ( user , category ) = \frac{Favorite ( user , category )}{Max Favorite ( user , category )} ;$$
Wherein NormaizeFavorite(user, category) represents a normalized preference value, MaxFavorite(user, category) represents a max preference value for each of the categories of the user identity.

17. The electronic device according to claim 13, wherein the execution of the instructions to select and push one or more videos from each of the categories to the terminal device for displaying according to the preference value for each of the categories of the user logging in the terminal device and the ranking result cause the at least one processor to:
select one or more videos from each of the categories according to the preference value for each of the categories of the user logging in the terminal device and the ranking result;
filter one or more videos which have been exposed to the user identity logging in the terminal device from the selected videos; and
push the videos after filtering to the terminal device for displaying.

18. The electronic device according to claim 13, wherein the execution of the instructions to select and push one or more videos from each of the categories to the terminal device for displaying according to the preference value for each of the categories of the user logging in the terminal device and the ranking result cause the at least one processor to:
select one or more videos from each of the categories according to the preference value for each of the categories of the user logging in the terminal device and the ranking result;
score and ranking the selected videos, wherein an amount of the videos belonging to the same category in the ranking result is less than or equal to a preset amount; and
push the ranked videos to the terminal device for displaying.
